(19) United States
(12) Patent Application Publication
(10) Pub. No.: US 2009/0210820 A1
(43) Pub. Date: Aug. 20, 2009

(54) DISPLAY OBJECT LAYOUT CHANGING DEVICE

(76) Inventors: Takao Adachi, Osaka (JP); Mitsuhiro Aso, Osaka (JP); Masaki Horiuchi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/300,168

(22) PCT Filed: Apr. 24, 2007
(86) PCT No.: PCT/JP2007/058853

§ 371 Date: Nov. 10, 2008

(30) Foreign Application Priority Data
May 11, 2006 (JP) 2006-132166

(51) Int. Cl. G06F 3/048

(52) U.S. Cl. 715/786; 715/788; 715/790; 715/800; 715/768

(57) ABSTRACT

A display object layout changing device for changing a layout of a new display object so that the new display object, made transparent, within a new display window does not overlap an existing display object within an existing display window, is provided. A new display object determination section (103) determines whether or not a transparency is set for the new display object. When the transparency is set, a display object layout determination section (104) determines whether or not the layout of the new display object is to be changed. When the layout of the new display object is to be changed, the display object layout changing section (105) changes the layout so that the new display object does not overlap the existing display object. A display control section (106) displays the new display window including the new display object, of which the layout has been changed, on the display screen.

### TECHNICAL FIELD

The present invention relates to a display object layout changing device for changing the layout of a new display object, and particularly to a display object layout changing device for changing the layout of a new display object so that the new display object, made transparent, within a new display window and an existing display object within an existing display window do not overlap each other when displayed.

### BACKGROUND ART

Conventionally, in an information processing apparatus or a digital consumer electronics device, such as a personal computer, a workstation, or a mobile phone, when a plurality of display contents are to be displayed concurrently on one screen (i.e., when multi-window display is to be performed), a plurality of rectangular areas, referred to as “windows”, are displayed, occasionally overlapping each other, on a display device, typified by that of CRT and that of liquid crystal.

In the above-described multi-window display, however, when a window already displayed is overlapped by a new window, all or a portion of the window already displayed is covered and hidden by the new window.

To solve this problem, when a plurality of windows are displayed, a conventional window display device makes some of the windows transparent (see Patent Document 1, for example). Patent Document 1: Japanese Laid-Open Patent Publication No. 11-249782

### DISCLOSURE OF THE INVENTION

### Problems to be Solved by the Invention

In the conventional window display device, however, when a window made transparent overlaps a display object, such as a character or a line, of another window immediately behind the transparent window, the overlapped display object becomes difficult to view. As a result, it may be difficult to understand what the overlapped display object, even though an important display object to be primarily displayed, is displaying. The above problem is serious particularly in the case of a terminal having a small display screen, such as a mobile phone, since, unlike the case of a personal computer or the like, a user cannot move the display positions of windows without causing the drawn objects of the windows to overlap each other.

Therefore, an object of the present invention is to solve the above conventional problem, and therefore is to provide a display object layout changing device for changing the layout of a new display object so that the new display object, made transparent, within a new display window and an existing display object, already displayed, within an existing display window do not overlap each other when displayed.

### Solution to the Problems

The present invention is directed to a display object layout changing device for changing layouts of a display window on a display screen and of a display object within a display window. To achieve the above object, the display object layout changing device of the present invention includes: a display window operation request communication section for receiving a request for displaying a new display window; a new display object determination section for receiving the request for displaying the new display window from the display window operation request communication section, and for determining whether or not a transparency is set for a new display object within the new display window; a display object management section for managing display object information regarding an existing display object, already displayed on the display screen; a display object layout change determination section for, when the new display object determination section determines that the transparency is set for the new display object, determining, based on a display content of the new display object and a display content of the existing display object within an existing display window, whether or not a layout of the new display object is to be changed; a display object layout changing section for, when the display object layout change determination section determines that the layout of the new display object is to be changed, changing the layout of the new display object so that the new display object does not overlap the existing display object; and a display control section for displaying the new display window including the new display object, of which the layout has been changed by the display object layout changing section, on the display screen.

The display object management section manages layout change determination conditions in which conditions for determining whether or not the layout of the new display object is to be changed, are set. The display object layout change determination section determines, using the layout change determination conditions and based on display object information regarding the new display object and the display object information regarding the existing display object, whether or not the layout of the new display object is to be changed.

It is preferable that the display object layout changing section includes a display object display position changing section for, when the new display window has space in which the new display object can be displayed without overlapping the existing display object, changing a display position of the new display object to a position in the space.

Further, the display object layout changing section may include a display object display position changing section for, when the display screen has space in which the new display object can be displayed without overlapping the existing display object, changing a display position of the new display object to a position in the space.

Further, the display object layout changing section may include a display object divided display position changing section for dividing a display area of the new display object into an area where the new display object does not overlap the existing display object, and for changing the display area of the new display object to the area into which the display area is divided.

Further, the display object layout changing section may include a display object scroll setting section for setting, in the new display object, a function of displaying the new display object in a scrolling manner based on a user's operation so that the new display object does not overlap the existing display object.

Further, the display object layout changing section may include a display object enlargement/reduction section for displaying the new display object, enlarging or reducing the new display object, so that the new display object does not overlap the existing display object.

It is preferable that the new display object determination section includes: a new display object transparency determination section for determining whether or not the transparency is set for the new display object; and an existing display object presence/absence determination section for determining whether or not the existing display object is present. In this case, when the new display object determination section determines that the transparency is set for the new display object and that the existing display object is present, the display object layout change determination section determines, based on the display content of the new display object and the display content of the existing display object within the existing display window, whether or not the layout of the new display object is to be changed.

The present invention is also directed to a display object layout changing method for changing layouts of a display window on a display screen and of a display object within a display window, and to a program executed by a display object layout changing device. The method and the program each includes: a new display object determination step of receiving a request for displaying a new display window, and of determining whether or not a transparency is set for a new display object within the new display window; a display object layout change determination step of, when it is determined that the transparency is set for the new display object, determining, based on a display content of the new display object and a display content of an existing display object within an existing display window, whether or not a layout of the new display object is to be changed; a display object layout changing step of, when it is determined that the layout of the new display object is to be changed, changing the layout of the new display object so that the new display object does not overlap the existing display object; and a display control step of displaying the new display window including the new display object, of which the layout has been changed, on the display screen.

### EFFECT OF THE INVENTION

As described above, based on the display object layout changing device of the present invention, it is possible to prevent a new display object, made transparent, within a new display window and an existing display object within an existing display window from overlapping each other when displayed, and thus it is possible to maintain the viewability of a display screen.

### BRIEF DESCRIPTION OF THE DRAWINGS

FIG. 1 is a block diagram showing an example of the structure of a display object layout changing device according to a first embodiment of the present invention.

FIG. 2A is a diagram showing an example of display objects on a display screen according to the first embodiment of the present invention.

FIG. 2B is a diagram showing an example of display object information 201 regarding the display objects on the display screen according to the first embodiment of the present invention.

FIG. 3 is a diagram showing an example of layout change determination conditions 301 used in the display object layout changing device according to the first embodiment of the present invention.

FIG. 4 is a flow chart showing an example of the operation of the display object layout changing device according to the first embodiment of the present invention.

FIG. 5A is a diagram showing an example of display objects on a display screen according to the first embodiment of the present invention.

FIG. 5B is a diagram showing an example of display object information regarding the display objects on the display screen according to the first embodiment of the present invention.

FIG. 6 is a block diagram showing an example of the structure of a display object layout changing device according to a second embodiment of the present invention.

FIG. 7 is a flow chart showing an example of the operation of the display object layout changing device according to the second embodiment of the present invention.

FIG. 8A is a diagram showing an example of display objects on a display screen according to the second embodiment of the present invention.

FIG. 8B is a diagram showing an example of display object information regarding the display objects on the display screen according to the second embodiment of the present invention.

FIG. 9 is a block diagram showing an example of the structure of a display object layout changing device according to a third embodiment of the present invention.

FIG. 10 is a flow chart showing an example of the operation of the display object layout changing device according to the third embodiment of the present invention.

FIG. 11A is a diagram showing an example of display objects on a display screen according to the third embodiment of the present invention.

FIG. 11B is a diagram showing an example of display object information regarding the display objects on the display screen according to the third embodiment of the present invention.

FIG. 12 is a block diagram showing an example of the structure of a display object layout changing device according to a fourth embodiment of the present invention.

FIG. 13 is a flow chart showing an example of the operation of the display object layout changing device according to the fourth embodiment of the present invention.

FIG. 14A is a diagram showing an example of display objects on a display screen according to the fourth embodiment of the present invention.

FIG. 14B is a diagram showing an example of display object information regarding the display objects on the display screen according to the fourth embodiment of the present invention.

### DESCRIPTION OF THE REFERENCE CHARACTERS

101 display object management section
102 window operation request communication section
103 new display object determination section
104 display object layout change determination section
105 display object layout changing section
106 display control section
107 display section
108 new display object transparency determination section
109 existing display object presence/absence determination section
1051 display object display position changing section
1052 display object divided display position changing section
1053 display object scroll setting section
1054 display object enlargement/reduction section
202, 521, 531, 831, 1131, 1431 display screen
502, 802, 1102, 1402 existing display object
512, 532, 812, 822, 823 new display object
1112, 1122, 1412, 1422 new display object

### BEST MODE FOR CARRYING OUT THE INVENTION

With reference to the drawings, embodiments of the present invention will be described below.

### First Embodiment

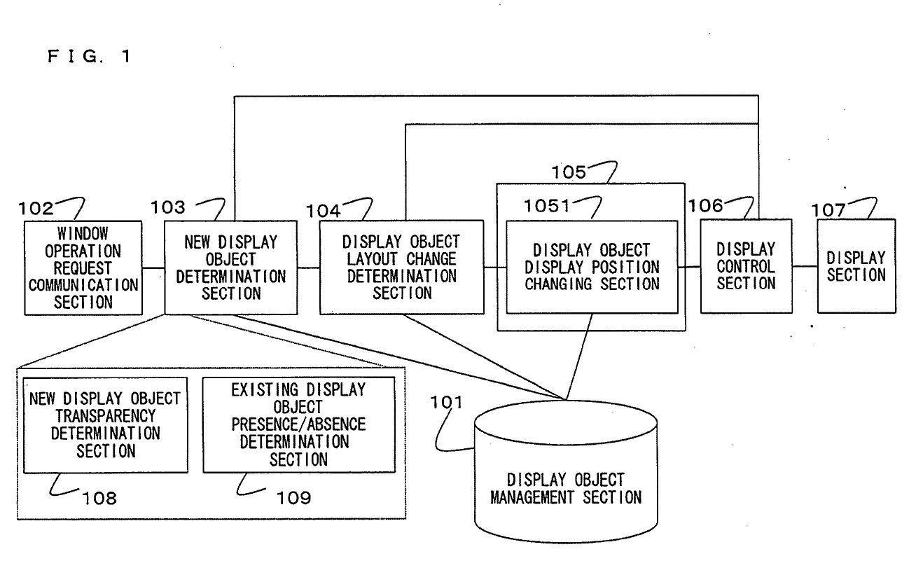

FIG. 1 is a block diagram showing an example of the structure of a display object layout changing device according to a first embodiment of the present invention. Referring to FIG. 1, the display object layout changing device includes a display object management section 101, a window operation request communication section 102, a new display object determination section 103, a display object layout change determination section 104, a display object layout changing section 105, a display control section 106, and a display section 107. Further, the display object layout changing section 105 includes a display object display position changing section 1051. The new display object determination section 103 includes a new display object transparency determination section 108 and an existing display object presence/absence determination section 109.

The display object management section 101 has stored therein information (hereinafter referred to as display object information) regarding a display object currently being displayed on a display screen of the display section 107. Here, the display object refers to a window or an object displayed within a window, and it is assumed that display objects managed by the display object management section 101 are all displayed on the display screen.

Further, here, it is also assumed that a transparency is set for a window to be newly displayed. When a transparency is not set for the window to be newly displayed, the display object layout changing device of the present invention does not change, in relation to an object already displayed, the layout of an object to be newly displayed.

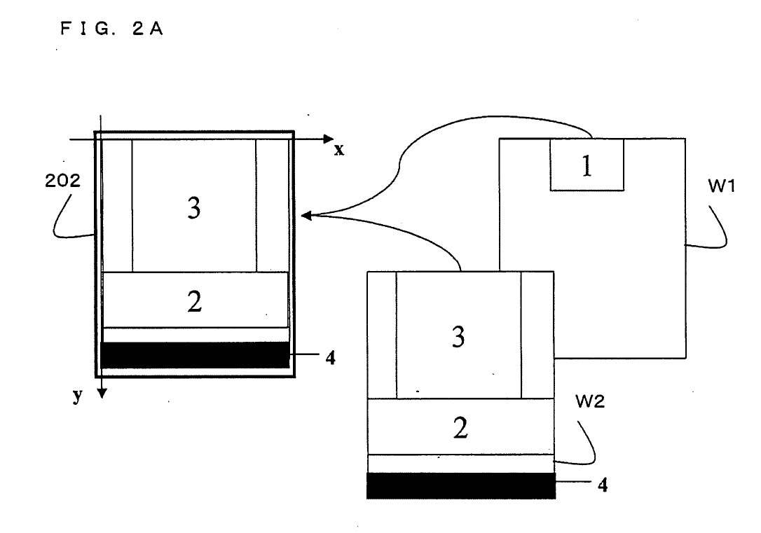

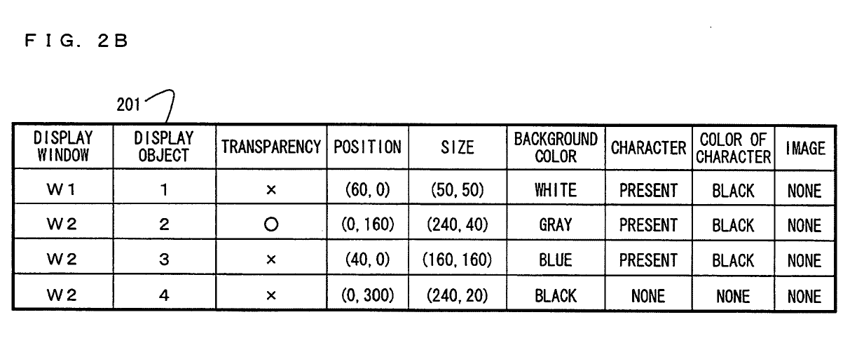

FIG. 2A is a diagram showing an example of the display objects on the display screen. FIG. 2B is a diagram showing an example of display object information 201 regarding the display objects on the display screen. Referring to FIG. 2A, x-coordinates and y-coordinates are set in a display screen 202, so as to be used to represent the position at which a display object within a display window is displayed.

A display window W1 is a window displayed on the display screen 202, and includes a display object 1. A display window W2 is a window displayed on the display screen 202, and includes a display object 2, a display object 3, and a display object 4.

Further, on the display screen 202, the display window W1 and the display window W2 are displayed, overlapping each other, and the display object 1 within the display window W1 is displayed, overlapping the display object 3 within the display window W2. Here, the display object 1 is covered and hidden by the display object 3 since a transparency is not set for the display object 3.

Referring to FIG. 2B, it is assumed that, as the display object information 201, information regarding the transparency, the position, the size, the background color, and the like of each display object is set. Here, the position represents the position of a display object displayed on the display screen 202, by the x-coordinates and the y-coordinates. The background color represents the background color of a display object. Further, the position and the size will be collectively referred to as a display area. Note that, as the display object information 201, information regarding the type of each display object, such as a character or an image, information regarding the shape of each display object, such as rectangular or circular, and the like may also be included, besides the above-described information.

The window operation request communication section 102 receives: an input from a user through an input device such as a key, a button, and a mouse; an external event such as phone call reception and e-mail reception; an instruction given by an arbitrary application; and the like, and then outputs display object information for displaying a display window to be newly displayed.

The new display object determination section 103 receives the new display object information from the window operation request communication section 102. Here, the display window to be newly displayed is defined as a new display window; a display object within a new display window is defined as a new display object; a display window already displayed is defined as an existing display window; and a display object within an existing display window is defined as an existing display object.

The new display object determination section 103 determines whether or not a transparency is set for the new display object, and also determines the presence or absence of the existing display object. Specifically, in the new display object determination section 103, the new display object transparency determination section 108 determines whether or not a transparency is set for the new display object, and the existing display object presence/absence determination section 109 determines the presence or absence of the existing display object. When it is determined that a transparency is set for the new display object and that the existing display object is present, the new display object determination section 103 notifies the display object layout change determination section 104 of the display object information regarding the new display object. On the other hand, when it is determined otherwise, the new display object determination section 103 registers the display object information regarding the new display object in the display object management section 101, and notifies the display control section 106 of the registered display object information. Display object information regarding the existing display object is already stored in the display object management section 101.

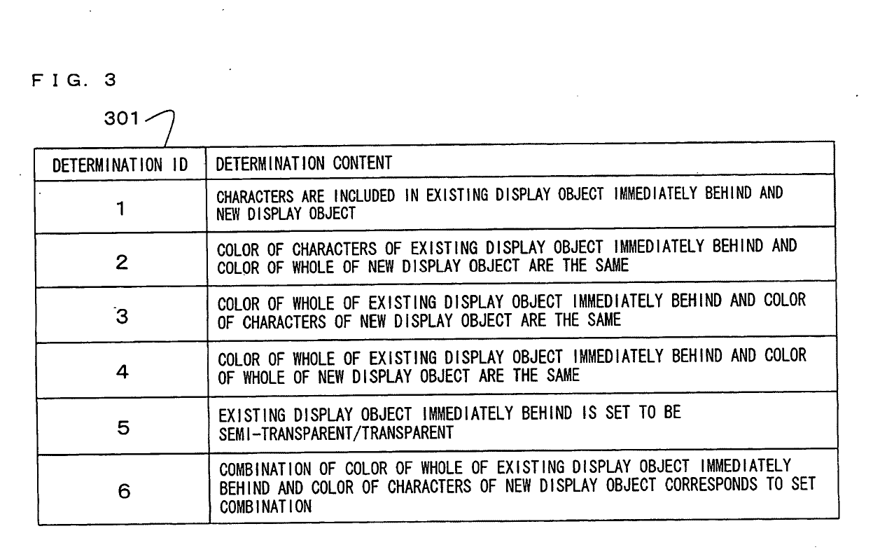

The display object layout change determination section 104 compares the display object information regarding the new display object, received from the new display object determination section 103, with the display object information regarding the existing display object, stored in the display object management section 101, and determines, using layout change determination conditions 301 as shown in FIG. 3, whether or not it is necessary to change the layout of the new display object.

FIG. 3 is a diagram showing the layout change determination conditions 301 used in the display object layout changing device according to the first embodiment of the present invention. As shown in FIG. 3, in the layout change determination conditions 301, determination IDs and determination contents corresponding to the determination IDs are set. For example, in a determination ID “1”, the condition that “characters are included in the existing display object immediately behind and the new display object” is set. In a determination ID “2”, the condition that “the color of the characters of the existing display object immediately behind and the color of the whole of the new display object are the same” is set. In a determination ID “3”, the condition that “the color of the whole of the existing display object immediately behind and the color of the characters of the new display object are the same” is set. In a determination ID “4”, the condition that “the color of the whole of the existing display object immediately behind and the color of the whole of the new display object are the same” is set. In a determination ID “5”, the condition that the existing display object immediately behind is set to be semi-transparent/transparent” is set. In a determination ID “6”, the condition that “the combination of the color of the whole of the existing display object immediately behind and the color of the characters of the new display object corresponds to a set combination” is set.

The display object layout change determination section 104 determines whether or not the new display object meets the conditions of FIG. 3. When the new display object meets these conditions, the display object layout change determination section 104 determines that the layout of the new display object is to be changed. When the new display object does not meet these conditions, the display object layout change determination section 104 determines that the layout is not to be changed. Note that in the present embodiment, tabular determination conditions as shown in FIG. 3 are used as the layout change determination conditions, but functions may also be used to determine whether or not to change the layout.

When it is determined that the layout is to be changed, the display object layout change determination section 104 notifies the display object layout changing section 105 of the display object information regarding the new display object. When it is determined that the layout is not to be changed, the display object layout change determination section 104 registers the display object information regarding the new display object in the display object management section 101, and notifies the display control section 106 of the registered display object information.

When the display object layout change determination section 104 determines that the layout of the new display object is to be changed, the display object layout changing section 105 changes the layout of the new display object so that the new display object does not overlap the existing display object.

Specifically, in the display object layout changing section 105, the display object display position changing section 1051 determines, based on the display object information regarding the new display object notified of by the display object layout change determination section 104 and based on the display object information regarding the existing display object, whether or not the new display window has space (an area) in which the new display object can be displayed without overlapping the existing display object. When it is determined that the new display window has space in which the new display object can be displayed without overlapping the existing display object, the display object display position changing section 1051 changes the display position of the new display object to a position in this space.

Note that the display object display position changing section 1051 may determine whether or not the display screen has space in which the new display object can be displayed without overlapping the existing display object, and when it is determined that the display screen has space in which the new display object can be displayed without overlapping the existing display object, the display object display position changing section 1051 may change the display position of the new display object to a position in this space.

Next, the display object display position changing section 1051 registers, in the display object management section 101, the display object information regarding the new display object, of which the display position has been changed, and notifies the display control section 106 of the registered display object information.

When the new display window (or the display screen) does not have space in which the new display object can be displayed, the display object display position changing section 1051 registers the display object information regarding the new display object in the display object management section 101 without changing the display object information regarding the new display object, and notifies the display control section 106 of the registered display object information.

The display control section 106 generates display data of the new display object, based on the display object information notified of by one of the new display object determination section 103, the display object layout change determination section 104, and the display object layout changing section 105, and displays the new display window in the display section 107, which is a display device such as that of CRT or liquid crystal.

Note that the display object layout changing device of the present invention is used not only when the new display window is displayed in the display section 107. The display object layout changing device can be applied to the above-described display process also when any type of display of a display window is performed, such as: displaying a display window all or a portion of which has been covered by the existing display window and which appears by closing the existing display window; and displaying a display window by moving it from the back to the front so as to be visible on the screen.

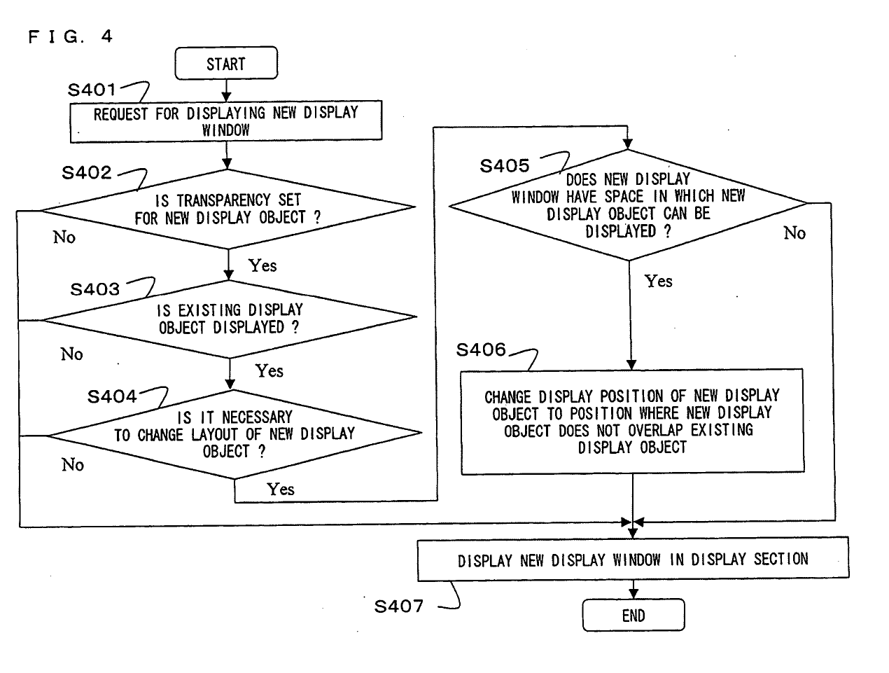

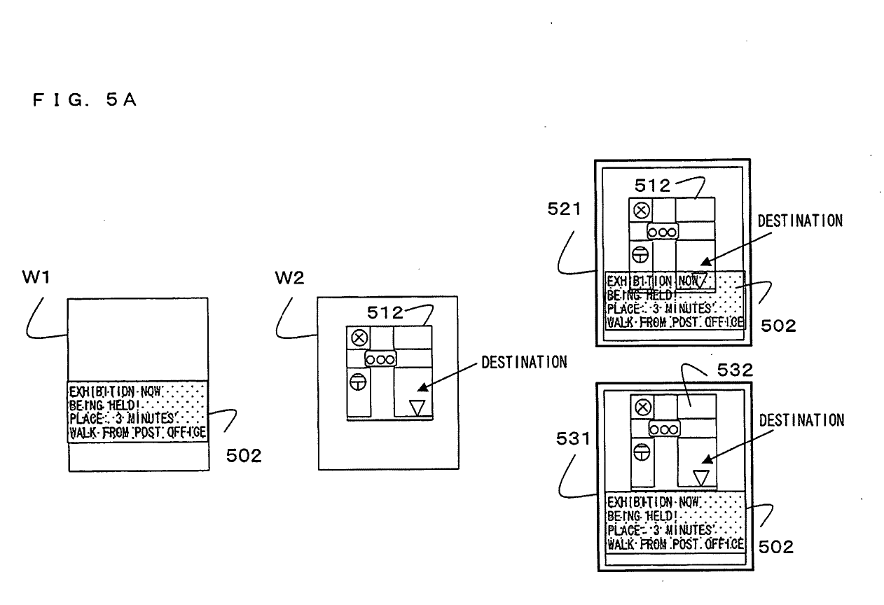

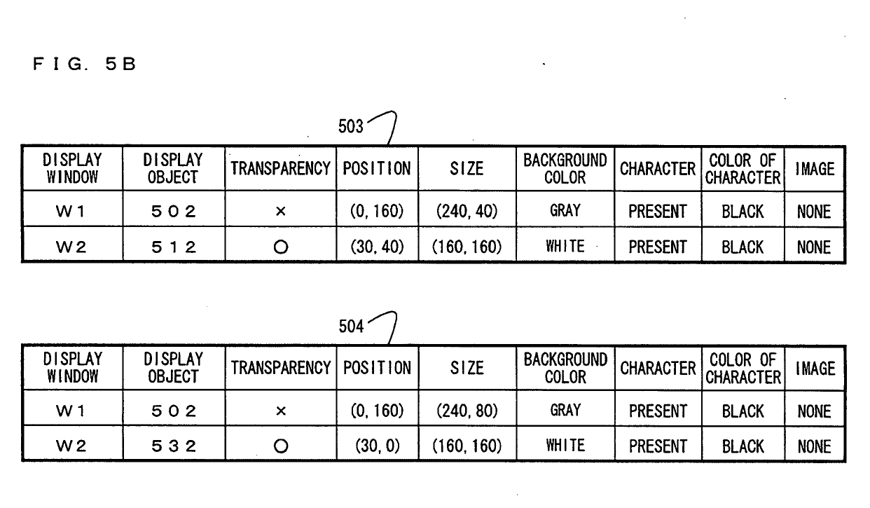

FIG. 4 is a flow chart showing an example of the operation of the display object layout changing device according to the first embodiment of the present invention. FIG. 5A is a diagram showing an example of display objects on a display screen. FIG. 5B is a diagram showing an example of display object information regarding the display objects on the display screen.

Referring to FIG. 5A, a display window W1 represents an existing display window and a display object 502 represents an existing display object within the display window W1. A display window W2 represents a new display window and a display object 512 represents a new display object within the display window W2.

A display screen 521 shows an example of a screen in which the new display window W2 overlaps the existing display window W1, and a portion of the new display object 512 overlaps the existing display object 502.

A display screen 531 shows an example of a screen in which, after the layout in the new display window W2 is changed so that the new display object 512 within the new display window W2 does not overlap the existing display object 502 within the existing display window W1, the new display window W2, in which the layout has been changed, overlaps the existing display window W1.

Referring to FIG. 5B, display object information 503 represents the display object information regarding the display objects, obtained before changing the layout (i.e., in the display screen 521). Display object information 504 represents the display object information regarding the display objects, obtained after changing the layout (i.e., in the display screen 531).

Here, with reference to FIGS. 4, 5A, and 5B, an example of the operation performed when the display object layout changing device displays the new display object 512 on the display screen, will be specifically described. Note that it is assumed that the existing display window W1 is displayed on the display screen.

First, in step S401, the window operation request communication section 102 receives a request for displaying the new display window W2 on the display screen. It is assumed that the new display window W2 includes the new display object 512.

Next, in step S402, the new display object determination section 103 determines whether or not a transparency is set for the new display object 512. When a transparency is set for the new display object 512, the process proceeds to step S403. On the other hand, when a transparency is not set for the new display object 512, the new display object determination section 103 notifies the display control section 106 of the display object information regarding the new display object 512, and the process proceeds to step S407.

In step S403, the new display object determination section 103 determines whether or not the existing display object is present. When the existing display object is present, the process proceeds to step S404. On the other hand, when the existing display object is not present, the new display object determination section 103 notifies the display control section 106 of the display object information regarding the new display object 512, and the process proceeds to step S407.

Here, since the existing display window W1 is displayed on the display screen, the new display object determination section 103 determines that the existing display object is present, and the process proceeds to step S404.

In step S404, the display object layout change determination section 104 determines whether or not it is necessary to change the layout of the new display object 512. Specifically, the display object layout change determination section 104 determines whether or not the new display object 512 is positioned to overlap the existing display object 502. When it is determined that the new display object 512 is positioned to overlap the existing display object 502, the display object layout change determination section 104 determines, using the layout change determination conditions as shown in FIG. 3, whether or not the new display object 512 meets the conditions for changing the layout.

When the new display object 512 meets the conditions for changing the layout, the process proceeds to step S405. On the other hand, when the new display object 512 is not positioned to overlap the existing display object 502 or when the new display object 512 does not meet the conditions for changing the layout, the display object layout change determination section 104 notifies the display control section 106 of the display object information regarding the new display object 512, and the process proceeds to step S407.

In step S405, the display object display position changing section 1051 determines whether or not the new display window W2 has space in which the new display object 512 can be displayed without overlapping the existing display object 502. Specifically, the display object display position changing section 1051 calculates the space in the new display window W2, using the position and the size included in the display object information as shown in FIG. 2B and the position and the size of the existing display object within the existing display window W1, and determines whether or not there is space to include the size of the new display object 512. When it is determined that there is the space, the process proceeds to step S406, so as to change the display position of the new display object 512. On the other hand, when it is determined that there is not the space, the display object display position changing section 1051 notifies the display control section 106 of the display object information regarding the new display object 512, and the process proceeds to step S407.

In step S406, the display object display position changing section 1051 changes the display position of the new display object 512 to a position where the new display object 512 does not overlap the existing display object 502. Specifically, the display object display position changing section 1051 changes the display position of the new display object 512 within the new display window W2 so that the new display object 512 does not overlap the existing display object 502. Here, as shown in FIG. 5A, the display position of the new display object 512 is changed to the display position of the new display object 532. Further, as shown in FIG. 5B, the display object information regarding the new display object 512 is updated to the display object information regarding the new display object 532. Then, the display object display position changing section 1051 notifies the display control section 106 of the display object information regarding the new display object 532, and the process proceeds to step S407.

In step S407, the display control section 106 displays the new display window in the display section 107, based on the display object information notified of.

Note that the layout change determination conditions 301 of FIG. 3 are retained by the display object layout change determination section 104, but may be retained by the display object management section 101. Further, the layout change determination conditions 301 may be set in advance or may be set by the user.

As described above, based on the display object layout changing device according to the first embodiment of the present invention, the new display object may be displayed in a position where the new display object does not overlap the existing display object, whereby it is possible to prevent the new display object, made transparent, within the new display window and the existing display object within the existing display window from overlapping each other when displayed, and thus it is possible to maintain the viewability of the display screen.

### Second Embodiment

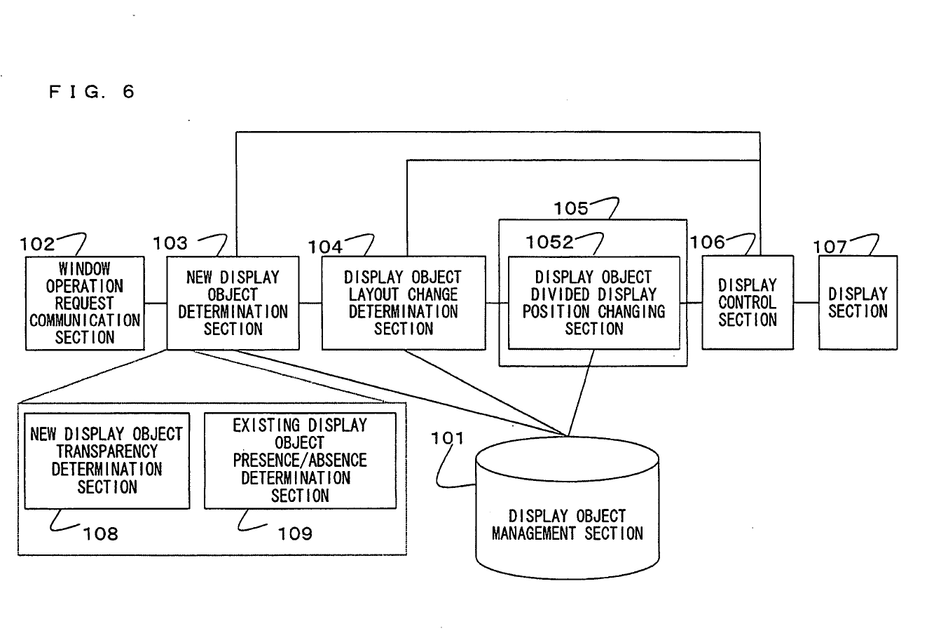

FIG. 6 is a block diagram showing an example of the structure of a display object layout changing device according to a second embodiment of the present invention. Referring to FIG. 6, the display object layout changing device is different from that of FIG. 1, in the structure of the display object layout changing section 105. The display object layout changing section 105 includes a display object divided display position changing section 1052 in place of the display object display position changing section 1051.

When notified of the display object information by the display object layout change determination section 104, the display object divided display position changing section 1052 determines whether or not the new display window has space in which the new display object can be displayed divided so as not to overlap the existing display object. When it is determined that the new display window has the space, the display object divided display position changing section 1052 changes the display position of the new display object to positions in an area divided so that the new display object does not overlap the existing display object. On the other hand, when it is determined that the new display window does not have the space, the display object divided display position changing section 1052 registers the display object information regarding the new display object in the display object management section 101, and notifies the display control section 106 of the registered display object information.

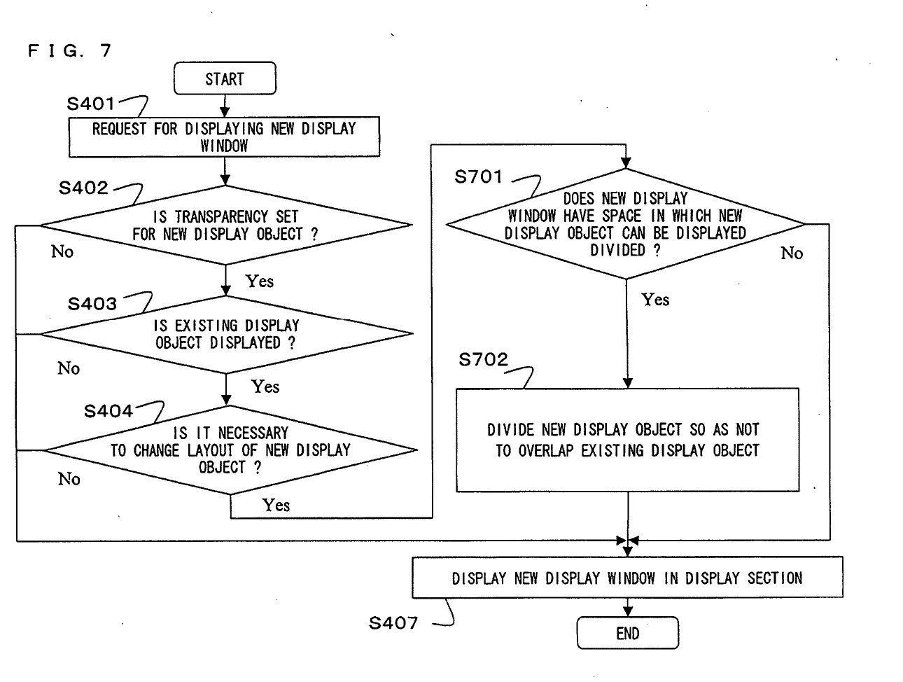

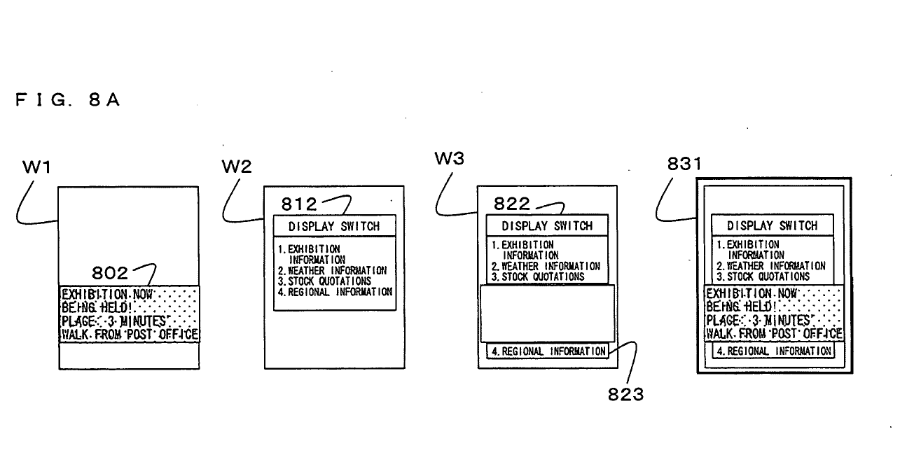

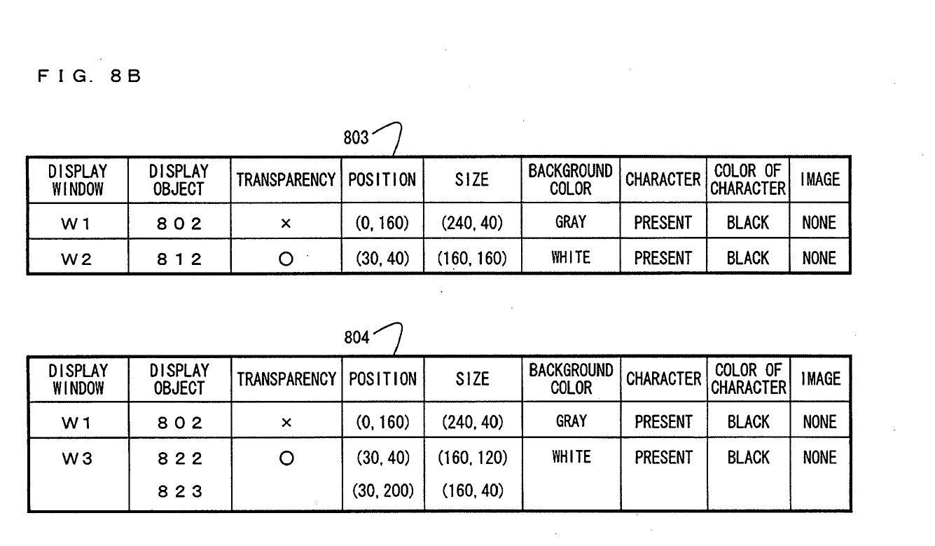

FIG. 7 is a f low chart showing an example of the operation of the display object layout changing device according to the second embodiment of the present invention. FIG. 8A is a diagram showing an example of display objects on a display screen. FIG. 8B is a diagram showing an example of display object information regarding the display objects on the display screen.

Referring to FIG. 8A, a display window W1 represents an existing display window and a display object 802 represents an existing display object within the display window W1. A display window W2 represents a new display window and a display object 812 represents a new display object within the display window W2.

A display window W3 represents a display window obtained after dividing the new display window W2. In the display window W3, the display object 812 is divided into a display object 822 and a display object 823. A display screen 831 shows an example where the existing display window W1 and the display window W3 are displayed, overlapping each other, and the new display object 812 within the new display window W2 is displayed divided so as not to overlap the existing display object 802.

Referring to FIG. 8B, display object information 803 represents the display object information regarding the display objects, obtained before changing the layout. Display object information 804 represents the display object information regarding the display objects, obtained after changing the layout (i.e., in the display screen 831).

Here, with reference to FIGS. 7, 8A, and 8B, an example of the operation performed when the display object layout changing device displays the new display object 812 on the display screen, will be specifically described. Note that it is assumed that the existing display window W1 is displayed on the display screen. Further, in the flow chart of FIG. 7, the process of steps S401 through S404 and step S407 is similar to that of FIG. 4, and therefore will not be described.

In step S701, the display object divided display position changing section 1052 determines whether or not the new display window W2 has space in which the new display object 812 can be displayed divided so as not to overlap the existing display object 802. When it is determined that there is the space, the process proceeds to step S702. On the other hand, when it is determined that there is not the space, the display object divided display position changing section 1052 notifies the display control section 106 of the display object information regarding the new display object 812, and the process proceeds to step S407.

In step S702, the display object divided display position changing section 1052 divides the new display object 812 into the new display object 822 and the new display object 823 so that the new display object 812 does not overlap the existing display object 802. Further, as shown in FIG. 8B, the display object information regarding the new display object 812 is updated to the display object information regarding the new display object 822 and the new display object 823. Then, the display object divided display position changing section 1052 notifies the display control section 106 of the display object information regarding the new display object 822 and the new display object 823, and the process proceeds to step S407.

Note that in the present embodiment, the new display object is divided into two new display objects, but may be divided into an arbitrary number of new display objects, which is more than two, in accordance with the state of the space in the new display window W2.

As described above, based on the display object layout changing device according to the second embodiment of the present invention, the new display object may be displayed divided so as not to overlap the existing display object, whereby it is possible, by making effective use of limited space in the display screen, to prevent the new display object, made transparent, within the new display window and the existing display object within the existing display window from overlapping each other when displayed, and thus it is possible to maintain the viewability of the display screen.

### Third Embodiment

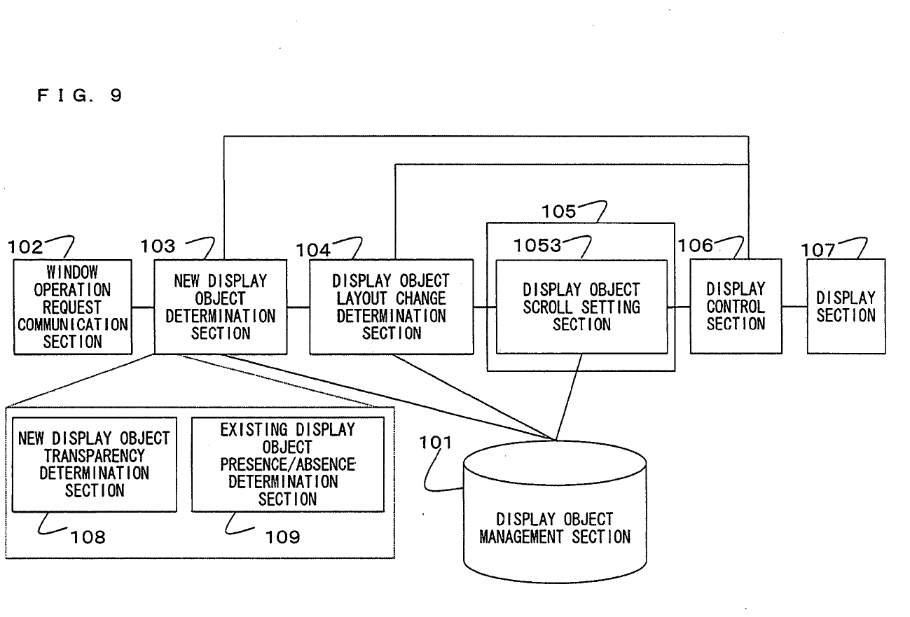

FIG. 9 is a block diagram showing an example of the structure of a display object layout changing device according to a third embodiment of the present invention. Referring to FIG. 9, the display object layout changing device is different from that of FIG. 1, in the structure of the display object layout changing section 105. The display object layout changing section 105 includes a display object scroll setting section 1053 in place of the display object display position changing section 1051.

When it is determined that it is necessary to change the layout of the new display object, the display object scroll setting section 1053 provides the new display object with a function of displaying the new display object in a scrolling manner based on the user's operation so that the new display object does not overlap the existing display object.

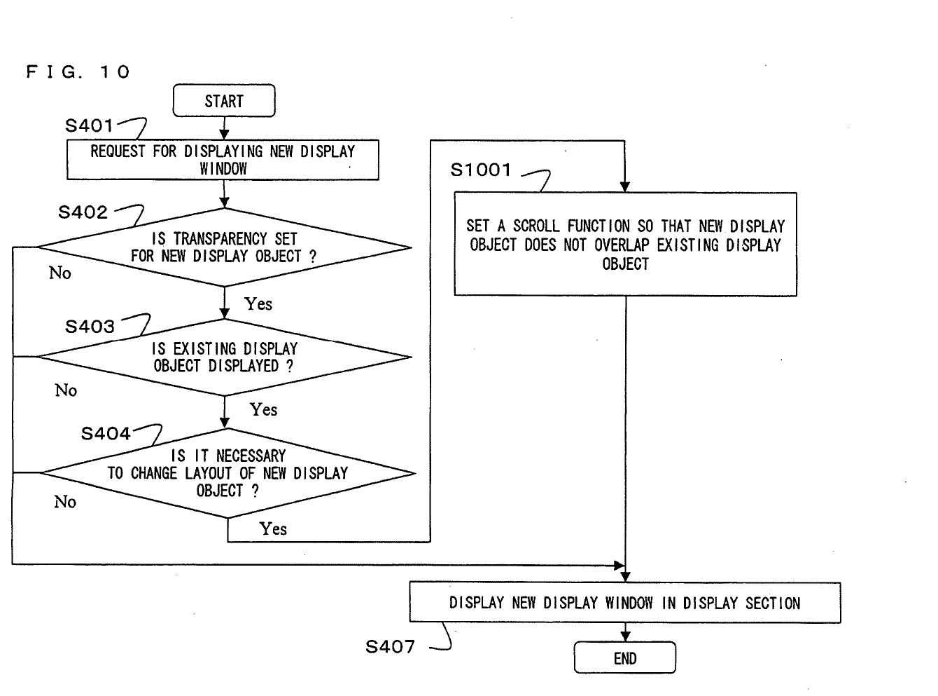

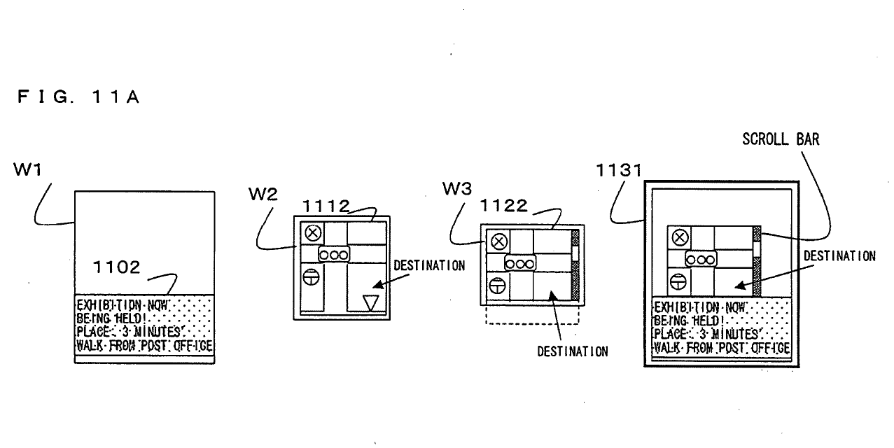

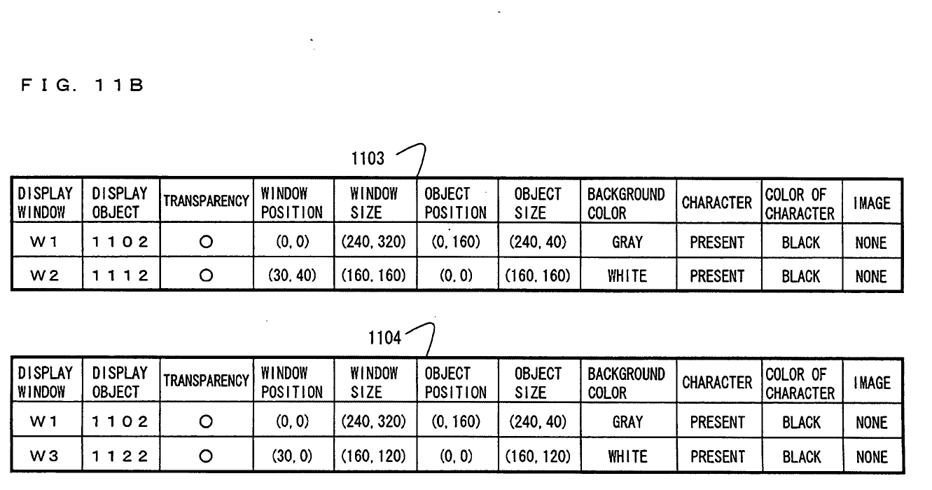

FIG. 10 is a flow chart showing an example of the operation of the display object layout changing device according to the third embodiment of the present invention. FIG. 1A is a diagram showing an example of display objects on a display screen. FIG. 11B is a diagram showing an example of display object information regarding the display objects on the display screen.

Referring to FIG. 11A, a display window W1 represents an existing display window and a display object 1102 represents an existing display object within the display window W1. A display window W2 represents a new display window and a display object 1112 represents a new display object within the display window W2.

A display window W3 represents a new display window including a new display object 1122, which is the new display object 1112 displayed in a scrolling manner. A display screen 1131 shows an example where the existing display window W1 and the new display window W3 are displayed, overlapping each other, and the new display object 1122 within the new display window W3 is displayed in a scrolling manner so that the new display object 1112 does not overlap the existing display object 1102.

Referring to FIG. 11B, display object information 1103 represents the display object information regarding the display objects, obtained before changing the layout. Display object information 1104 represents the display object information regarding the display objects, obtained after changing the layout (i.e., in the display screen 1131).

Here, with reference to FIGS. 10, 11A, and 11B, an example of the operation performed when the display object layout changing device displays the new display object 1112 on the display screen, will be specifically described. Note that it is assumed that the existing display window W1 is displayed on the display screen. Further, in the flow chart of FIG. 10, the process of steps S401 through S404 and step S407 is similar to that of FIG. 4, and therefore will not be described.

When the display object layout change determination section 104 determines that it is necessary to change the layout of the new display object, the display object scroll setting section 1053 sets, in step S1001, a scroll function in the new display object 1122 so that the new display object 1112 does not overlap the existing display object 1102. Further, as shown in FIG. 11B, the display object information regarding the new display object 1112 is updated to the display object information regarding the new display object 1122. Then, the display object scroll setting section 1053 notifies the display control section 106 of the display object information regarding the new display object 1122, and the process proceeds to step S407.

As described above, based on the display object layout changing device according to the third embodiment of the present invention, the new display object may be displayed in a scroll manner so as not to overlap the existing display object, whereby it is possible, by making effective use of limited space in the display screen, to prevent the new display object, made transparent, within the new display window and the existing display object within the existing display window from overlapping each other when displayed, and thus it is possible to maintain the viewability of the display screen.

### Fourth Embodiment

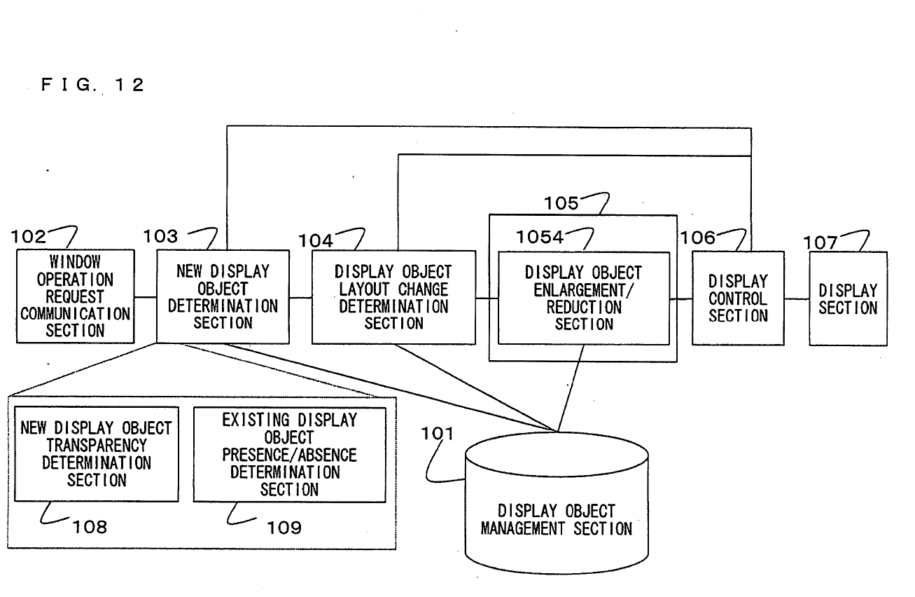

FIG. 12 is a block diagram showing an example of the structure of a display object layout changing device according to a fourth embodiment of the present invention. Referring to FIG. 12, the display object layout changing device is different from that of FIG. 1, in the structure of the display object layout changing section 105. The display object layout changing section 105 includes a display object enlargement/reduction section 1054 in place of the display object display position changing section 1051.

When it is determined that it is necessary to change the layout of the new display object, the display object enlargement/reduction section 1054 displays the new display object, enlarging/reducing it, so that the new display object does not overlap the existing display object.

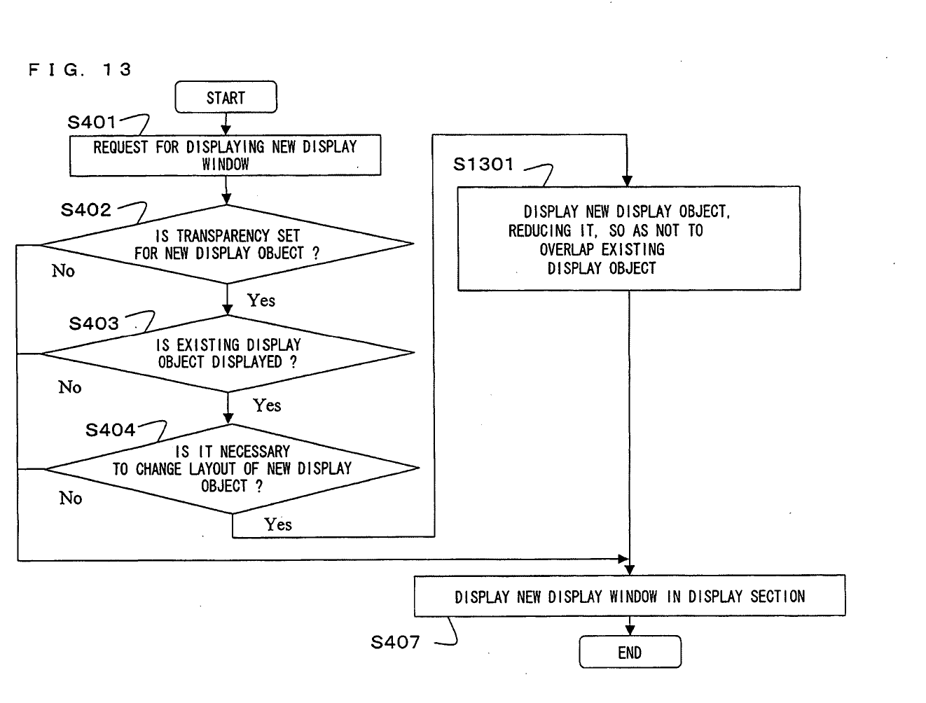

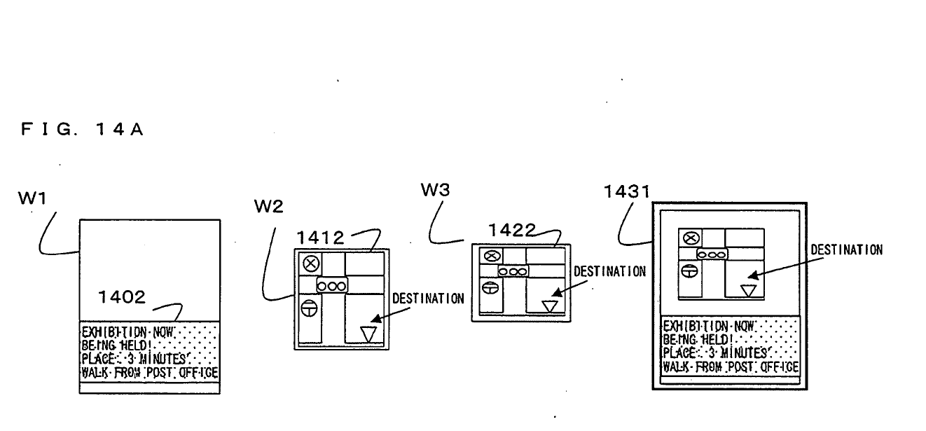

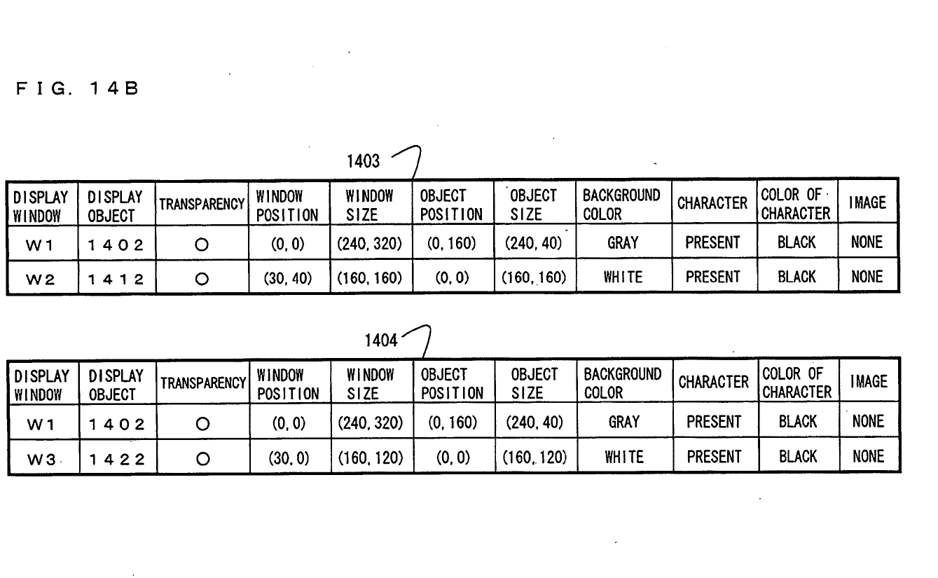

FIG. 13 is a flow chart showing an example of the operation of the display object layout changing device according to the fourth embodiment of the present invention. FIG. 14A is a diagram showing an example of display objects on a display screen. FIG. 14B is a diagram showing an example of display object information regarding the display objects on the display screen.

Referring to FIG. 14A, a display window W1 represents an existing display window and a display object 1402 represents an existing display object within the display window W1. A display window W2 represents a new display window and a display object 1412 represents a new display object within the display window W2.

A display window W3 represents a new display window including a new display object 1422, which is the reduced new display object 1412. A display screen 1431 shows an example where the existing display window W1 and the new display window W3 are displayed, overlapping each other, and the new display object 1422 within the new display window W3 is displayed reduced so that the new display object 1412 does not overlap the existing display object 1402.

Referring to FIG. 14B, display object information 1403 represents the display object information regarding the display objects, obtained before changing the layout. Display object information 1404 represents the display object information regarding the display objects, obtained after changing the layout (i.e., in the display screen 1431).

Here, with reference to FIGS. 13, 14A, and 14B, an example of the operation performed when the display object layout changing device displays the new display object 1412 on the display screen, will be specifically described. Note that it is assumed that the existing display window W1 is displayed on the display screen. Further, in the flow chart of FIG. 13, the process of steps S401 through S404 and step S407 is similar to that of FIG. 4, and therefore will not be described.

When the display object layout change determination section 104 determines that it is necessary to change the layout of the new display object, the display object enlargement/reduction section 1054 displays, in step S1301, the new display object 1412, reducing it, so that the new display object 1412 does not overlap the existing display object 1402. Further, as shown in FIG. 14B, the display object information regarding the new display object 1412 is updated to the display object information regarding the new display object 1422. Then, the display object enlargement/reduction section 1054 notifies the display control section 106 of the display object information regarding the new display object 1422, and the process proceeds to step S407.

As described above, based on the display object layout changing device according to the fourth embodiment of the present invention, the new display object may be displayed enlarged/reduced so as not to overlap the existing display object, whereby it is possible, by making effective use of limited space of the display screen, to prevent the new display object, made transparent, within the new display window and the existing display object within the existing display window from overlapping each other when displayed, and thus it is possible to maintain the viewability of the display screen.

Note that in all of the above embodiments, the new display object determination section 103, the display object layout change determination section 104, and the display object layout changing section 105 each notify the display control section 106 of the display object information regarding the new display object, per se, but may only instruct the display control section 106 to display the new display object on the display screen without even notifying the display control section 106 of the display object information. In this case, the display control section 106 may acquire the display object information regarding the new display object from the display object management section 101 and display the new display object on the display screen based on the acquired display object information.

Further, the new display object determination section 103, the display object layout change determination section 104, and the display object layout changing section 105 each registers the display object information in the display object management section 101 when notifying the display control section 106 of the display object information, but the display control section 106 may register the display object information in the display object management section 101 after being notified of the display object information.

Note that all of the functional blocks, i.e., the display object management section 101, the window operation request communication section 102, the new display object determination section 103, the display object layout change determination section 104, the display object layout changing section 105, the display control section 106, and the like may typically be realized as an LSI, which is an integrated circuit. Each of the functional blocks may be separately manufactured as a single chip, or all or some of the functional blocks may be manufactured as a single chip.

The integration circuit is here referred to as an LSI, but may be referred to as an IC, a system LSI, a super LSI, an ultra LSI, etc., depending on the degree of integration.

Further, the method of integration is not limited to LSI, and may be realized by a dedicated circuit or a general-purpose processor. An FPGA (Field Programmable Gate Array), which is an LSI that can be programmed after manufacture, or a reconfigurable processor capable of reconfiguring the connections and the settings of the circuit cells in the LSI may also be used.

Furthermore, in the case where another integration technology replacing LSI becomes available due to improvement of a semiconductor technology or due to the emergence of another technology derived therefrom, integration of the functional blocks may be performed using such a new integration technology. For example, biotechnology may be applied to the above-described integration.

### INDUSTRIAL APPLICABILITY

The display object layout changing device according to the present invention is useful for, for example, displaying display objects on the screen of a device, such as a mobile phone and a personal digital assistant, which is so small that a display object is likely to hide another display object.

1. A display object layout changing device for changing layouts of a display window on a display screen and of a display object within a display window, comprising:
a display window operation request communication section for receiving a request for displaying a new display window;
a new display object determination section for receiving the request for displaying the new display window from the display window operation request communication section, and for determining whether or not a transparency is set for a new display object within the new display window;
a display object management section for managing display object information regarding an existing display object, already displayed on the display screen;
a display object layout change determination section for, when the new display object determination section determines that the transparency is set for the new display object, determining, based on a display content of the new display object and a display content of the existing display object within an existing display window, whether or not a layout of the new display object is to be changed;
a display object layout changing section for, when the display object layout change determination section determines that the layout of the new display object is to be changed, changing the layout of the new display object so that the new display object does not overlap the existing display object; and
a display control section for displaying the new display window including the new display object, of which the layout has been changed by the display object layout changing section, on the display screen.

2. The display object layout changing device according to claim 1,
wherein the display object management section manages layout change determination conditions in which conditions for determining whether or not the layout of the new display object is to be changed, are set, and
wherein the display object layout change determination section determines, using the layout change determination conditions and based on display object information regarding the new display object and the display object information regarding the existing display object, whether or not the layout of the new display object is to be changed.

3. The display object layout changing device according to claim 1,
wherein the display object layout changing section includes a display object display position changing section for, when the new display window has space in which the new display object can be displayed without overlapping the existing display object, changing a display position of the new display object to a position in the space.

4. The display object layout changing device according to claim 1,
wherein the display object layout changing section includes a display object display position changing section for, when the display screen has space in which the new display object can be displayed without overlapping the existing display object, changing a display position of the new display object to a position in the space.

5. The display object layout changing device according to claim 1,
wherein the display object layout changing section includes a display object divided display position changing section for dividing a display area of the new display object into an area where the new display object does not overlap the existing display object, and for changing the display area of the new display object to the area into which the display area is divided.

6. The display object layout changing device according to claim 1,
wherein the display object layout changing section includes a display object scroll setting section for setting, in the new display object, a function of displaying the new display object in a scrolling manner based on a user's operation so that the new display object does not overlap the existing display object.

7. The display object layout changing device according to claim 1,
wherein the display object layout changing section includes a display object enlargement/reduction section for displaying the new display object, enlarging or reducing the new display object, so that the new display object does not overlap the existing display object.

8. The display object layout changing device according to claim 1,
wherein the new display object determination section includes:
a new display object transparency determination section for determining whether or not the transparency is set for the new display object; and
an existing display object presence/absence determination section for determining whether or not the existing display object is present, and
wherein, when the new display object determination section determines that the transparency is set for the new display object and that the existing display object is present, the display object layout change determination section determines, based on the display content of the new display object and the display content of the existing display object within the existing display window, whether or not the layout of the new display object is to be changed.

9. A display object layout changing method for changing layouts of a display window on a display screen and of a display object within a display window, comprising:
a new display object determination step of receiving a request for displaying a new display window, and of determining whether or not a transparency is set for a new display object within the new display window;
a display object layout change determination step of, when it is determined that the transparency is set for the new display object, determining, based on a display content of the new display object and a display content of an existing display object within an existing display window, whether or not a layout of the new display object is to be changed;
a display object layout changing step of, when it is determined that the layout of the new display object is to be changed, changing the layout of the new display object so that the new display object does not overlap the existing display object; and
a display control step of displaying the new display window including the new display object, of which the layout has been changed, on the display screen.

10. A program executed by a display object layout changing device for changing layouts of a display window on a display screen and of a display object within a display window, comprising:
a new display object determination step of receiving a request for displaying a new display window, and of determining whether or not a transparency is set for a new display object within the new display window;
a display object layout change determination step of, when it is determined that the transparency is set for the new display object, determining, based on a display content of the new display object and a display content of an existing display object within an existing display window, whether or not a layout of the new display object is to be changed;
a display object layout changing step of, when it is determined that the layout of the new display object is to be changed, changing the layout of the new display object so that the new display object does not overlap the existing display object; and
a display control step of displaying the new display window including the new display object, of which the layout has been changed, on the display screen.
